(19) United States
(12) Patent Application Publication
(10) Pub. No.: US 2004/0046970 A1
(43) Pub. Date: Mar. 11, 2004

(54) Automatic adjustment and recovery system and method

(75) Inventor: Hiroki Miyachi, Kawasaki-shi (JP)

Correspondence Address: FOLEY AND LARDNER, SUITE 500, 3000 K STREET NW, WASHINGTON, DC, 20007, US

(73) Assignee: TOSHIBA TEC KABUSHIKI KAISHA

(21) Appl. No.: 10/235,858

(22) Filed: Sep. 6, 2002

(51) Int. Cl. G06F 15/00; G06K 1/00

(52) U.S. Cl. 358/1.1; 358/1.13

(57) ABSTRACT

A system and method for providing continuous execution of an image processing device includes receiving a job request from a user, the job request having one or more job settings, and determining if a device which receives the job request can satisfy each of the job settings in the job request. An accommodation rule is identified from a rule table having a plurality of accommodation rules if at least one of the job settings of the job request cannot be satisfied. The identified accommodation rule is performed if at least one of the job settings of the job request cannot be satisfied.

### FIELD OF THE INVENTION

The present invention relates generally to image processing systems, and more particularly to an image processing system and method for accommodating unworkable conditions arising from the processing of an image processing job.

### BACKGROUND OF THE INVENTION

Image processing functions include, among other things, printing, copying, faxing and scanning. These functions can be performed by separate image processing devices, such as copiers, printers, faxes and scanners. Alternatively, a single image processing device, sometimes referred to as a multi-function peripheral (MFP) device, can perform all of these functions itself.

When creating a job for a hardcopy device, a user may set one or more settings for completing the job. For example, the user may set a job to be completed on a certain size paper, with a particular orientation, hole punching or with a staple. In some circumstances, the hardcopy device may be unable to satisfy or perform one or more of the settings of the job submitted by the user.

To resolve such a situation in a conventional system, one of two approaches is typically followed. One response is that the hardcopy device stops performing the job, and the user needs to provide input to the hardcopy device to fix or change the parameter that cannot be performed or satisfied. The other approach can be referred to as auto continue. When the hardcopy device is set to auto continue, the job is still processed, but the setting that cannot be satisfied or performed is ignored. It is also possible in a conventional system for the job to simply skip the job if any of the parameters cannot be satisfied or performed.

### SUMMARY OF THE INVENTION

Briefly, in one aspect of the invention, a method for providing continuous execution of an image processing device includes receiving a job request from a user, the job request having one or more job settings, and determining if a device which receives the job request can satisfy each of the job settings in the job request. An accommodation rule is identified from a rule table having a plurality of accommodation rules if at least one of the job settings of the job request cannot be satisfied. The identified accommodation rule is performed if at least one of the job settings of the job request cannot be satisfied.

### BRIEF DESCRIPTION OF THE DRAWINGS

FIG. 1 is a block diagram of a communication system consistent with the present invention.

FIG. 2 is a flow diagram of an adjustment and recovery process consistent with the present invention.

### DETAILED DESCRIPTION OF THE PREFERRED EMBODIMENTS

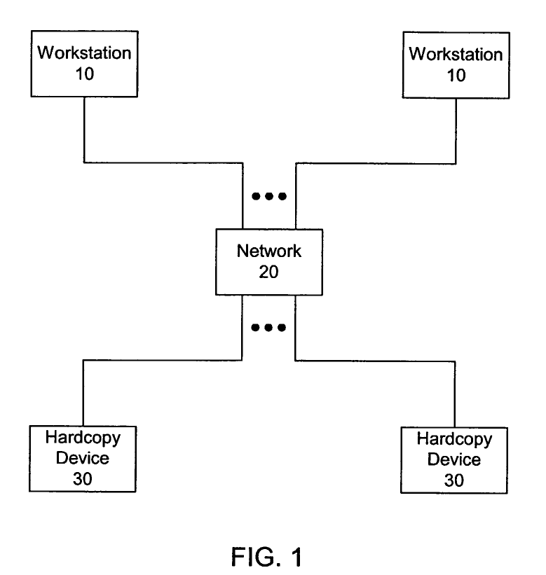

FIG. 1 is a block diagram of a communication system consistent with the present invention. As shown in FIG. 1, the communication system includes one or more workstations 10, a network 20, and one or more hardcopy devices 30. Each of the workstations 10 and each of the hardcopy devices 30 are coupled to the network 20. The network 20 may be implemented as a local network, such as a LAN, or as a public network, such as the Internet.

The workstation 10, which may be a PC or a server, includes a CPU, a main memory, a ROM, a storage device and a communication interface all coupled together via a bus in one embodiment consistent with the present invention. The CPU may be implemented as a single microprocessor or as multiple processors for a multi-processing system. The main memory is preferably implemented with a RAM and a smaller-sized cache. The ROM is a non-volatile storage, and may be implemented, for example, as an EPROM or NVRAM. The storage device can be a hard disk drive or any other type of non-volatile, writable storage.

The communication interface for the workstation 10 provides a two-way data communication coupling via a network link to the network 20. For example, if the communication interface is an integrated services digital network (ISDN) card or a modem, the communication interface provides a data communication connection to the corresponding type of telephone line. If the communication interface is a local area network (LAN) card, the communication interface provides a data communication connection to a compatible LAN. Wireless links are also possible. In any such implementation, the communication interface sends and receives electrical, electromagnetic or optical signals, which carry digital data streams representing different types of information, to and from the network 20.

If the network 20 is implemented as the Internet, the workstation 10 or server can transmit a requested code for an application program through the Internet, an ISP, the local network and the communication interface. The received code can be executed by the CPU in the workstation or server as it is received, stored in the storage device, or stored in some other non-volatile storage for later execution. In this manner, a user at the workstation or server may obtain application code in the form of a carrier wave.

The hardcopy device 30 is a device which can perform the function of, for example, a printer, a fax machine, a copier, a plotter, a scanner or any other functional device that generates or processes images or text. Hardcopy devices 30 can also be devices, such as multi-function peripherals (MFPs), which are capable of performing the functions of two or more image processing devices, such as a combination of any of printing, faxing, copying, plotting and scanning. Like the workstation 10, the hardcopy device 30 may have a CPU, a main memory, a ROM, a storage device and a communication interface all coupled together via a bus. The hardcopy device 30 may also have a communication interface to provide a two-way data communication coupling via a network link to the network 20. The network link to the network 20 enables the hardcopy device 30 to receive data from and to output data to the workstation 10. Instead of a network link, hardcopy devices 30 may use a Universal Serial Bus (USB) to connect to a USB port on the workstation 10.

In operation, the workstations 10 communicate with the hardcopy devices 30 via the network 20 or via a more direct connection, such as the USB. This communication enables the workstation 10 to request the hardcopy device 30 to perform a function, such as print a document or send or receive a fax. In addition, the workstation 10 can request information from the hardcopy device 30.

To communicate with the hardcopy device 30, the workstation 10 may use a network protocol such as SNMP, which is a protocol for monitoring and managing systems and devices in a network. The functions supported by the protocol are the request and retrieval of data, the setting or writing of data, and traps that signal the occurrence of events. The data being monitored and managed is defined by a management information base (MIB). A MIB includes the specification and formal description of a set of objects and variables that can be read and possibly written using the SNMP protocol. SNMP and similar communication protocols can also be used with non-networked connections, such as USB, FireWire and IEEE 1284 (Parallel).

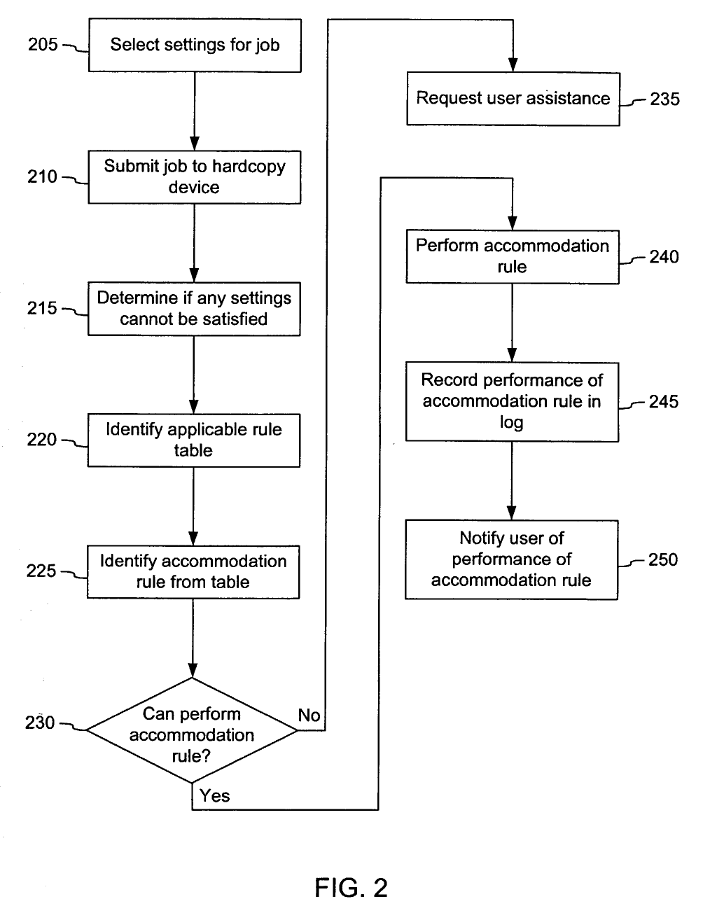

FIG. 2 is a flow diagram of an adjustment and recovery process consistent with the present invention. As shown in FIG. 2, a user first selects the setting for a job (step 205). The job may be, for example, a print, fax, scan or copy job. For any of these types of job, there are a number of settings that the user can select for the processing of the job. These settings include, for example, the size of the paper, the orientation of the image, the use and location of a staple, the use and location of hole punches, the resolution, as well as any other settings that may be used to designate a parameter for the processing of a job.

To select the settings, the user may set the parameters using the user's workstation 10. For example, to create a print job, the user can designate settings for the print job through a word processing application in which the document to be printed is located. Alternatively, the user may set the parameters at a hardcopy device 30. For example, to create a copy job, the user may designate the settings for the copy job though an interface panel on the hardcopy device 30.

After selecting the settings for the job, the user submits the job to the hardcopy device 30 (step 210). The job can be submitted to the hardcopy device 30 by the user from the user's workstation 10. Alternatively, the job can be submitted to the hardcopy device 30 at the hardcopy device 30 itself, such as selecting a start job button on the hardcopy device 30.

The submitted job, if not submitted at the hardcopy device 30, can include an identification of the hardcopy device 30 that the user has selected to process the job. Alternatively, the job may go to a centralized queue of jobs from which the jobs are assigned to an available hardcopy device from among a plurality of hardcopy devices.

The submitted job is received at the hardcopy device 30 designated to process the job. The hardcopy device 30 analyzes the job, including the associated settings of the job, and determines if it is unable to perform or satisfy any of the settings (step 215). As described above, the job can include a number of settings selected by the user that the hardcopy device 30 uses to process the job. In some situations, the hardcopy device 30 is not capable of processing the job in accordance with one or more of the settings selected by the user. For example, the user may have submitted a print job with a setting to have a document printed on A4 paper. If the hardcopy device 30 to which the print job was submitted only has letter sized paper, then the hardcopy device 30 is not capable of performing the paper size setting included in the print job.

There are numerous other examples of settings that can be selected by the user that cannot be performed by the hardcopy device 30, such as being unable to place a hole punch in a proper position. For example, a print setting to position a hole punch at the top of a page is supported for an A4 page having a landscape orientation, but not for an A3 page having a landscape orientation. Accordingly, if it is detected that a page is to print on A3 having a landscape orientation, the hole punch setting cannot be satisfied, resulting in an unworkable condition.

In the conventional system, in response to an unworkable condition in which the hardcopy device 30 is incapable of processing one or more settings of a job, the problematic setting is either ignored or further user input to correct the problematic setting is required. Consistent with the present invention, such a problematic setting can be handled without ignoring the setting or requiring further user input. Instead of ignoring the setting or requiring further user input, an accommodation rule can be applied. For example, if the setting is for A4 paper, and the hardcopy device 30 only has letter sized paper, the accommodation rule could be to print on the letter sized paper, or whatever sized paper is available at the hardcopy device 30.

As shown in FIG. 2, if any of the settings of the job cannot be satisfied or performed, an applicable corrective rule table is identified (step 220). A corrective rule tables includes information that is referred to when an unworkable condition, i.e., a setting that cannot be performed or satisfied, is met to determine a course of action to accommodate the unworkable condition. Each table can include one or more unworkable conditions that may occur for each hardcopy device 30. For each unworkable condition, the table includes an accommodation rule to be performed in place of the unworkable condition. The accommodation rule enables the hardcopy device 30 to continue to process the job without ignoring the unworkable condition or requiring further user input. For example, if the setting is for A4 paper, and the hardcopy device 30 only has letter sized paper, the accommodation rule could be to print on the letter sized paper, or whatever sized paper is available at the hardcopy device 30. If the accommodation rule is also unworkable, there can be one or more backup accommodation rules identified in the table that can be performed in place of the unworkable condition.

The corrective rule table can be stored in each hardcopy device 30 or stored in a centralized location, such as a server, to which each hardcopy device 30 can refer. In addition, each user may have a different corrective rule table for each particular hardcopy device 30. For example, the user may have a first corrective rule table for a first type of hardcopy device 30 and have a second corrective rule table, different from the first table, for a second type of hardcopy device 30 different from the first type.

There are a variety of ways in which the corrective rule tables can be created and modified. For example, each hardcopy device 30 can include software configured to create and modify the corrective rule tables. This software may be, for example, part of the installation hardware of the hardcopy device 30, part of the driver software to enable a workstation 10 to communication with the hardcopy device 30, or part of a plug-in application for the hardcopy device 30.

To create or modify the corrective rule table, this software provides an interface, such as a graphical user interface (GUI), through which a user or administrator can create or modify the corrective rule table. To assist in the creation of the corrective rule table, the software can provide a default corrective rule table with a default accommodation rule for each unworkable condition that may occur for the particular type of hardcopy device 30. The user or administrator can accept the default accommodation rule or have a different accommodation rule in place of the default accommodation rule. For example, the user or administrator can select an accommodation rule from a drop down menu of possible accommodation rules for the particular unworkable condition. In addition, the user or administrator can elect to have one or more backup accommodation rules that would take effect in the event the selected accommodation rule also cannot be performed.

After the user or administrator has selected accommodation rules for each unworkable condition, the corrective rule table is saved to include these selections. The corrective rule table also includes information identifying to which hardcopy devices 30 and users the corrective rule table is applicable. For example, the corrective rule table can be applicable to a particular hardcopy device 30 or to any of a particular type of hardcopy device, such as for a particular version of a printer. In addition, the corrective rule table can be applicable to a particular user for one or more hardcopy devices 30, such as to the particular user who created the corrective rule table. Alternatively, the corrective rule table can be applicable to each of the users of the network for one or more hardcopy devices, such as when the corrective rule table is created by an administrator to be applicable to each of the users of the network.

To identify the applicable rule table, the hardcopy device 30 first determines the location of the corrective rule table. The corrective rule table can be located in a storage section of the hardcopy device 30. Alternatively, the corrective rule table can be stored in a centralized storage location, such as a server. After determining the location, the hardcopy device 30 determines which corrective rule table is applicable. As described above, each hardcopy device 30 can have its own corrective rule table. In addition, each user can have a different corrective rule table for each hardcopy device 30. Accordingly, to determine the applicable corrective rule table, the identity of the hardcopy device 30 with the unworkable condition and/or the identity of the user submitting the job can be used.

The corrective rule table can include information identifying the hardcopy device 30 to which it is applicable, as well as information identifying the user associated with the corrective rule table. To match these identifiers, the corrective rule table can be implemented, for example, as part of a relational database. If no corrective rule table is identified that matches the hardcopy device 30 and/or the user, a default corrective rule table can be used, such as one associated with the type of hardcopy device 30 having the unworkable condition. The default corrective rule table can have default accommodation rules to handle any unworkable condition that may arise. Alternatively, the accommodation rules for the default corrective rule table may be set by a system administrator. For example, the system administrator can set the accommodation rules for default corrective rule tables for each type of hardcopy device 30 coupled to the network 20.

With the applicable corrective rule table identified, an accommodation rule from the applicable corrective rule table is identified (step 225). The accommodation rule is identified in accordance with the unworkable condition arising at the hardcopy device 30. To identify the accommodation rule according to the unworkable condition, the unworkable condition can be keyed to the applicable corrective rule table, which associates an accommodation rule with the particular unworkable condition. This identification can be facilitated by implementing the corrective rule table in a relational database.

The identified accommodation rule is provided to the hardcopy device 30 to be performed in place of the unworkable condition. If the corrective rule table is stored in the hardcopy device 30 itself, then the identified accommodation rule can be provided to the hardcopy device 30 without transmitting the identified accommodation rule through the network 20. If the corrective rule table is stored in a location outside of the hardcopy device 30, such as at a server, then the identified accommodation rule would be provided to the hardcopy device 30 via the network 20.

Based on the identified accommodation rule, it is determined whether or not the hardcopy device 30 can perform the accommodation rule (step 230). As described above, the hardcopy device 30 is not capable of processing the job in accordance with one or more of the settings selected by the user. This inability to process the particular setting may also apply to the processing of the accommodation rule. For example, if the user submitted a print job with a setting to have a document printed on A3 paper, and the accommodation rule was to print on A4 paper instead, but the hardcopy device 30 to which the print job was submitted only has letter sized paper, then the hardcopy device 30 is not capable of performing the paper size setting included in the print job or in the accommodation rule.

If the hardcopy device 30 cannot perform the accommodation rule or any backup or default accommodation rules, then a request can be issued for further assistance from the user (step 235). This request can be issued directly to the user, such as at the user's workstation 10. The request can be shown to the user, for example, in a pop-up window or by e-mail. The content of the request may include an explanation of the unworkable condition and an explanation of why one or more accommodation rules were also unworkable. In addition, the content of the request may propose an accommodation not set forth in the corrective rule table, but which could be performed or processed by the hardcopy device 30. The user could signal the acceptance of this accommodation, such as be clicking a button in the window, and an acknowledgment of this acceptance would be received by the hardcopy device 30, which could then proceed with processing the job submitted by the user.

If the hardcopy device 30 is capable of performing the accommodation rule, then it does so (step 240). For example, as described above, if the setting in the job submitted by the user was to print on A4 paper, and the accommodation rule is to print on letter-sized paper, which the hardcopy device 30 can do, then the accommodation rule is performed in place of the setting which cannot be performed. It is also possible, before the accommodation rule is performed, to request approval of the accommodation rule by the user. The approval request can appear as a pop-up window at the user's workstation 10 or by e-mail. To approve the use of the accommodation rule, the user can, for example, click a button in the pop-up window to accept or reject the accommodation rule. In the event approval from the user is requested, there can be a waiting period after which, if the hardcopy device 30 does not receive acknowledgment from the user, then either the job is skipped or the accommodation rule is performed. The approval by the user is not necessary, however, as the accommodation rule can be performed by the hardcopy device 30 automatically.

In addition to performing the accommodation rule, the performance of the accommodation rule is recorded in a log (step 245). The log maintains information about each unworkable condition and any accommodation rule performed to satisfy the unworkable condition. The log may be maintained as a table that includes information, such as, a description of the unworkable condition, an identification of the job and the user submitting the job in which the unworkable condition occurred, the accommodation rule that was used to overcome the unworkable condition, the time at which the unworkable condition occurred and any other information that may be related to the unworkable condition and the accommodation rule used to overcome it. Each hardcopy device 30 can maintain its own log. Alternatively, a centralized log, which can be stored for example in a server on the network 20, can maintain the log information for each of the hardcopy devices 30 on the network 20.

In the event that an accommodation rule is applied to the processing of the job submitted by the user, the user can be notified of the performance of the accommodation rule (step 250). To notify the user, the log information can be sent to the user, such as in a pop-up window or via e-mail. In addition to being notified, it is possible for the user to view the log information from the user's workstation 10 at the discretion of the user. For example, the user could click on a status screen for a hardcopy device 30, such as a printer, where the status screen would include the log information regarding the performance of accommodation rules.

Consistent with the present invention, jobs submitted by a user can be processed continuously without interruption, even when a setting in the job cannot be satisfied or performed by the hardcopy device 30. In addition, instead of ignoring the unworkable condition arising from the problematic setting, an accommodation rule can be applied, which results in the processing of an alternative setting to the problematic setting. The accommodation rules can applied by default. In addition, the user or a network administrator is capable of setting the accommodation rules for any possible unworkable condition. The use of accommodation rules to overcome an unworkable condition can be recorded in a log, and a user can be notified when an accommodation rule is used to perform the processing of a job submitted by the user.

The foregoing description of a preferred embodiment of the invention has been presented for purposes of illustration and description. It is not intended to be exhaustive or to limit the invention to the precise form disclosed, and modifications and variations are possible in light in the above teachings or may be acquired from practice of the invention. The embodiment was chosen and described in order to explain the principles of the invention and as practical application to enable one skilled in the art to utilize the invention in various embodiments and with various modifications are suited to the particular use contemplated. It is intended that the scope of the invention be defined by the claims appended hereto and their equivalents.

What is claimed is:

1. A method for providing continuous execution of an image processing device, comprising:
receiving a job request from a user, the job request having one or more job settings;
determining if a device which receives the job request can satisfy each of the job settings in the job request;
identifying an accommodation rule from a rule table having a plurality of accommodation rules if at least one of the job settings of the job request cannot be satisfied; and
performing the identified accommodation rule if at least one of the job settings of the job request cannot be satisfied.

2. A method according to claim 1, further comprising recording the performance of the accommodation rule in a log.

3. A method according to claim 2, further comprising sending data recorded in the log to the user in response to a request from the user.

4. A method according to claim 1, further comprising notifying the user of the performance of the accommodation rule.

5. A method according to claim 1, further comprising:
identifying the user submitting the request; and
identifying a rule table from a plurality of rule tables that corresponds to the identified user from which to identify the accommodation rule.

6. A method according to claim 1, further comprising:
identifying the device receiving the job request; and
identifying a rule table from a plurality of rule tables that corresponds to the identified device from which to identify the accommodation rule.

7. A method according to claim 1, further comprising issuing a request for further user input if the identified accommodation rule cannot be performed.

8. A method according to claim 1, wherein the accommodation rule sets an alternative setting to be performed in place of the setting that cannot be satisfied.

9. A method according to claim 1, further comprising:
identifying a backup accommodation rule if the initially identified accommodation rule cannot be performed; and
performing the identified backup accommodation rule.

10. A method according to claim 1, further comprising modifying at least one of the plurality of accommodation rules in the rule table.

11. An image processing device, comprising:
a processor; and
a memory, coupled to the processor, the memory comprising a plurality of instructions executed by the processor, the plurality of instructions configured to:
receive a job request from a user, the job request having one or more job settings;
determine if each of the job settings in the job request can be satisfied by the image processing device;
identify an accommodation rule from a rule table having a plurality of accommodation rules if at least one of the job settings of the job request cannot be satisfied; and
perform the identified accommodation rule if at least one of the job settings of the job request cannot be satisfied.

12. An image processing device according to claim 11, the memory further comprising an instruction configured to record the performance of the accommodation rule in a log.

13. An image processing device according to claim 12, the memory further comprising an instruction configured to send data recorded in the log to the user in response to a request from the user.

14. An image processing device according to claim 11, the memory further comprising an instruction configured to notify the user of the performance of the accommodation rule.

15. An image processing device according to claim 11, the memory further comprising instructions configured to:
identify the user submitting the request; and
identify a rule table from a plurality of rule tables that corresponds to the identified user from which to identify the accommodation rule.

16. An image processing device according to claim 11, the memory further comprising an instruction configured to identify a rule table from a plurality of rule tables that corresponds to the image processing device from which to identify the accommodation rule.

17. An image processing device according to claim 11, the memory further comprising an instruction configured to issue a request for further user input if the identified accommodation rule cannot be performed.

18. An image processing device according to claim 11, wherein the accommodation rule sets an alternative setting to be performed in place of the setting that cannot be satisfied.

19. A system according to claim 11, the memory further comprising an instruction configured to:
identify a backup accommodation rule if the initially identified accommodation rule cannot be performed; and
perform the identified backup accommodation rule.

20. A system according to claim 11, the memory further comprising an instruction configured to modify at least one of the plurality of accommodation rules in the rule table.

21. A computer readable medium operable in a computer system configured to provide continuous execution of an image processing device, the computer readable medium configured to:
receive a job request from a user, the job request having one or more job settings;
determine if a device which receives the job request can satisfy each of the job settings in the job request;
identify an accommodation rule from a rule table having a plurality of accommodation rules if at least one of the job settings of the job request cannot be satisfied; and
perform the identified accommodation rule if at least one of the job settings of the job request cannot be satisfied.

22. A computer readable medium according to claim 21, further configured to record the performance of the accommodation rule in a log.

23. A computer readable medium according to claim 22, further configured to send data recorded in the log to the user in response to a request from the user.

24. A computer readable medium according to claim 21, further configured to notify the user of the performance of the accommodation rule.

25. A computer readable medium according to claim 21, further configured to:
identify the user submitting the request; and
identify a rule table from a plurality of rule tables that corresponds to the identified user from which to identify the accommodation rule.

26. A computer readable medium according to claim 21, further configured to:
identify the device receiving the job request; and
identify a rule table from a plurality of rule tables that corresponds to the identified device from which to identify the accommodation rule.

27. A computer readable medium according to claim 21, further configured to issue a request for further user input if the identified accommodation rule cannot be performed.

28. A computer readable medium according to claim 21, wherein the accommodation rule sets an alternative setting to be performed in place of the setting that cannot be satisfied.

29. A computer readable medium according to claim 21, further configured to:
identify a backup accommodation rule if the initially identified accommodation rule cannot be performed; and
perform the identified backup accommodation rule.

30. A computer readable medium according to claim 21, further configured to modify at least one of the plurality of accommodation rules in the rule table.
